(19) United States
(12) Patent Application Publication
(10) Pub. No.: US 2023/0052225 A1
(43) Pub. Date: Feb. 16, 2023

(54) METHODS AND COMPUTER SYSTEMS FOR AUTOMATED EVENT DETECTION BASED ON MACHINE LEARNING

(71) Applicant: Deep Labs Inc., San Mateo, CA (US)

(72) Inventors: Scott EDINGTON, Arlington, VA (US); Jiri NOVAK, Mill Valley, CA (US); Theodore HARRIS, San Francisco, CA (US); Simon NILSSON, Asheville, NC (US); Thomas STEARNS, Medford, MA (US); Keith TAYLOR, Arlington, VA (US)

(21) Appl. No.: 17/886,633

(22) Filed: Aug. 12, 2022

Related U.S. Application Data
(60) Provisional application No. 63/260,249, filed on Aug. 13, 2021.
(60) Provisional application No. 63/260,443, filed on Aug. 19, 2021.

(51) Int. Cl. G06N 5/04; G06Q 30/02

(52) U.S. Cl. CPC G06N 5/04; G06Q 30/0203; G06Q 30/0201

(57) ABSTRACT

A computer system includes a memory configured to store instructions, and one or more processors configured to execute the instructions to cause the computer system to perform a method for event detection. The method includes obtaining a user profile and a persona category associated with the user profile corresponding to a user; receiving first data associated with the user and second data associated with one or more environmental or situational factors; detecting an event based on the first data or the second data; and querying a database in response to the detected event to determine one or more recommended actions for the user based on the user profile and the persona category of the user.

### CROSS REFERENCE TO RELATED APPLICATIONS

This application claims the benefit of priority to U.S. Provisional Application No. 63/260,249 filed on Aug. 13, 2021 and U.S. Provisional Application No. 63/260,443 filed on Aug. 19, 2021, both of which are incorporated herein by reference in their entireties.

### TECHNICAL FIELD

The present disclosure generally relates to machine learning analysis. More specifically, and without limitation, the present disclosure relates to systems and methods for using machine learning analysis to detect high-impact or influencer events.

### BACKGROUND

Conventional techniques for monitoring digital activity often focus on few variables, do not understand relationships between variables, and fail to detect patterns for relevant feedback. For example, some systems may present an alert when a single particular variable is detected. However, these techniques fail to provide deeper analysis of digital behavior that could potentially produce more rapid or relevant feedback, which may benefit a user in real-time. For instance, some traditional responsive actions taken based on monitored digital activity may lack insight or appropriate timing. In some situations, analyzing data from a single device, user, or variable may present a myopic informational perspective. Moreover, many actions taken in response to monitoring simply include a basic notification, which may be blocked by an application, may fail to receive a user's attention or prevent potential harmful impacts to the user when a high-impact event occurs, or may otherwise fail to prevent a user from taking a specific action.

Machine learning (ML) and artificial intelligence (AI) based systems can be used in various applications to provide streamlined user experiences on digital platforms. While streamlining the user experience may be beneficial in terms of convenience, it may present issues in terms of security risks, overconsumption, developing bad habits, and encouraging users to engage in unfavorable behaviors. The nature of digital platforms may encourage users to engage in activities that are not in the user's best interest, but instead are designed to maximize the benefits of another. For example, merchants may use AI/ML systems to target users susceptible to making certain kinds of purchases. Merchants may design the workflow, checkout procedure, and look-and-feel of a digital platform to make it easier for the user to make a purchase, although the user would probably not have made that purchase if given more opportunity to consider whether the purchase was necessary or prudent. The user may not be made aware of other important considerations, such as the fact that they will have insufficient funds in light of other upcoming obligations, but may be rushed into completing an operation on a digital platform.

Meanwhile, AI/ML systems have access to enormous amounts of data and computing resources that can be used to help guide users to reach more desirable outcomes. Consumers have grown accustomed to AI/ML systems monitoring their activities and aiding them in important decisions in some aspects, such as making recommendations for sleep habits, exercise, and other health-related issues. However, there remains a need for providing AI/ML systems to guide users in making informed decisions while interacting with digital platforms, especially in real-time as the user is using the digital platforms.

### SUMMARY

In accordance with some embodiments, a method for event detection is provided. The method includes: obtaining a user profile and a persona category associated with the user profile corresponding to a user; receiving first data associated with the user and second data associated with one or more environmental or situational factors; detecting an event based on the first data or the second data; and querying a database in response to the detected event to determine one or more recommended actions for the user based on the user profile and the persona category of the user.

In accordance with some embodiments, a computer system is provided. The computer system includes a memory configured to store instructions, and one or more processors configured to execute the instructions to cause the computer system to: obtain a user profile and a persona category associated with the user profile corresponding to a user; receive first data associated with the user and second data associated with one or more environmental or situational factors; detect an event based on the first data or the second data; and query a database in response to the detected event to determine one or more recommended actions for the user based on the user profile and the persona category of the user.

In accordance with some embodiments, a computer system is provided. The computer system includes: a data enrichment unit configured to combine source data received from a plurality of data sources; a data reduction and embedding unit configured to transform the source data into a uniform embedding; and a graph projection unit configured to project the uniform embedding into a uniform graph structure by generating links from embedding source data using predefined metrics.

It is to be understood that both the foregoing general description and the following detailed description are exemplary and explanatory only and are not restrictive of the disclosed embodiments, as may be claimed.

### BRIEF DESCRIPTION OF DRAWINGS

FIG. 1 is a diagram of an exemplary server for performing an event detection, consistent with some embodiments of the present disclosure.

FIG. 2 is a diagram of an exemplary user device, consistent with some embodiments of the present disclosure.

FIG. 3 is a diagram showing an exemplary workflow in a first exemplary scenario, consistent with some embodiments of the present disclosure.

FIG. 4 is a diagram showing an exemplary workflow in a second exemplary scenario, consistent with some embodiments of the present disclosure.

FIG. 5 is a diagram showing an exemplary workflow in a third exemplary scenario, consistent with some embodiments of the present disclosure.

FIG. 6 is a diagram showing an exemplary workflow in a fourth exemplary scenario, consistent with some embodiments of the present disclosure.

FIG. 7 is a diagram showing an exemplary workflow in a fifth exemplary scenario, consistent with some embodiments of the present disclosure.

FIG. 8 is a flowchart diagram of an exemplary computer-implemented method for event detection, consistent with some embodiments of the present disclosure.

FIG. 9 is a diagram illustrating exemplary operations performed during an onboarding process, consistent with some embodiments of the present disclosure.

FIG. 10 is a diagram illustrating an exemplary questionnaire, consistent with some embodiments of the present disclosure.

FIG. 11 is a flowchart diagram of exemplary detailed operations performed for an influencer event detection, consistent with some embodiments of the present disclosure.

FIG. 12 is a diagram of an exemplary processing engine for automated profiling, behavior change monitoring, and anomaly detection, consistent with some embodiments of the present disclosure.

FIG. 13 is a flowchart diagram of exemplary detailed operations performed by the processing engine of FIG. 12, consistent with some embodiments of the present disclosure.

FIG. 14 is a cluster map showing exemplary clusters of identity data, consistent with some embodiments of the present disclosure.

FIG. 15 is a diagram of an exemplary receiver operating characteristic (ROC) curve, consistent with some embodiments of the present disclosure.

FIG. 16 is another cluster map showing clusters of exemplary financial data, consistent with some embodiments of the present disclosure.

FIG. 17 is a chart showing the exemplary financial data after one or more analyses, consistent with some embodiments of the present disclosure.

FIG. 18 is a graph showing exemplary clusters of events and user profiles, consistent with some embodiments of the present disclosure.

FIG. 19 is another diagram of exemplary ROC curves, consistent with some embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to subject matter described herein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

AI/ML systems may enable the use of large amounts of data stored in databases, data gathered in knowledge-bases, peer information, or data that is otherwise available, such as environmental information. AI/ML systems can quickly analyze massive amounts of data and can provide a user with useful feedback that may guide the user to reach desirable outcomes.

AI/ML systems may be employed to monitor users and may determine to provide digital interventions to users. Technology may track a user and the user's peer groups from their use of digital platforms (e.g., use of mobile devices), network information, or other information relating to the user, the user's environment, and/or the environment of the user's peer groups. User information may be blended with environmental information (e.g., weather, news developments, market data, etc.) to provide rich signals for AI processing. An AI tier may use these signals to determine whether to provide a digital intervention to a user, and what kind of digital intervention may be beneficial to the user. A set of rules may be provided that can be used to create a targeted plan for a user that may disincentivize bad outcomes and/or incentivize good outcomes.

Digital interventions may impede a user's interactions with a digital platform. Digital interventions may create intelligent friction. For example, digital interventions may cause the user's interactions with the digital platform to be less seamless, but may improve the user's overall experience. Digital interventions may provide a deeper analysis of digital behavior, and thus produce more rapid or relevant feedback. Digital interventions may offer users a benefit in real-time as they are interacting with a digital platform, such as a graphical user interface. Digital interventions may include digital-action-controlling actions. Such actions may be useful to prevent the occurrence of unintended or harmful digital activities (e.g., occurring within a web browser, such as an action dangerous to cyber security or financial resources).

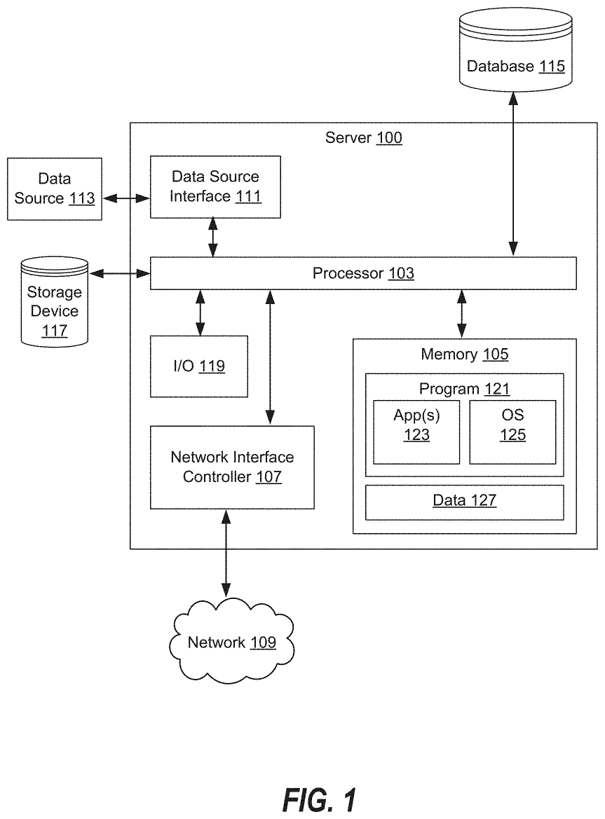

FIG. 1 illustrates a server 100 for performing an event detection, consistent with embodiments of the present disclosure. As shown in FIG. 1, the server 100 may include a processor 103, a memory 105, and a network interface controller 107. The processor 103, which may be a single-core processor or a multi-core processor, includes at least one processor configured to execute one or more programs 121, applications, processes, methods, or other software to perform disclosed embodiments of the present disclosure. In some embodiments, the processor 103 may include one or more circuits, microchips, microcontrollers, microprocessors, central processing unit, graphics processing unit, digital signal processor, or other suitable circuits for executing instructions stored in the memory 105, but the present disclosure is not limited thereto. It is understood that other types of processor arrangements could be implemented.

As shown in FIG. 1, the processor 103 is configured to communicate with the memory 105. The memory 105 may include one or more programs 121 and data 127. In some embodiments, the memory 105 may include any area where the processor 103 or a computer stores the data 127. A non-limiting example of the memory 105 may include semiconductor memory, which may either be volatile or non-volatile. For example, the non-volatile memory may include flash memory, ROM, PROM, EPROM, and EEPROM memory. The volatile memory may include dynamic random-access memory (DRAM) and static random-access memory (SRAM), but the present disclosure is not limited thereto.

The program 121 stored in the memory 105 may refer to a sequence of instructions in any programming language that the processor 103 may execute or interpret. Non-limiting examples of program 121 may include an operating system (OS) 125, web browsers, office suites, or video games. The program 121 may include at least one of server application(s) 123 and the operating system 125. In some embodiments, the server application 123 may refer to software that provides functionality for other program(s) 121 or devices. Non-limiting examples of provided functionality may include facilities for creating web applications and a server environment to run them. Non-limiting examples of server application 123 may include a web server, a server for static web pages and media, a server for implementing business logic, a server for mobile applications, a server for desktop applications, a server for integration with a different database, and any other similar server type. For example, the server application 123 may include a web server connector, a computer programming language, runtime libraries, database connectors, or administration code. The operating system 125 may refer to software that manages hardware, software resources, and provides services for programs 121. The operating system 125 may load the program 121 into the memory 105 and start a process. Accordingly, the processor 103 may perform this process by fetching, decoding, and executing each machine instruction.

As shown in FIG. 1, the processor 103 may communicate with the network interface controller 107. The network interface controller 107 may refer to hardware that connects a computer or the processor 103 to a network 109. In some embodiments, the network interface controller may be a network adapter, a local area network (LAN) card, a physical network interface card, an ethernet controller, an ethernet adapter, a network controller, or a connection card. The network interface controller 107 may be connected to the network 109 wirelessly, by wire, by USB, or by fiber optics. The processor 103 may communicate with an external or internal database 115, which may function as a repository for a collection of data 127. The database 115 may include relational databases, NoSQL databases, cloud databases, columnar databases, wide column databases, object-oriented databases, key-value databases, hierarchical databases, document databases, graph databases, and other similar databases. The processor 103 may communicate with a storage device 117. The storage device 117 may refer to any type of computing hardware that is used for storing, porting, or extracting data files and objects. For example, the storage device 117 may include random access memory (RAM), read-only memory (ROM), floppy disks, and hard disks.

In addition, the processor 103 may communicate with a data source interface 111 configured to communicate with a data source 113. In some embodiments, the data source interface 111 may refer to a shared boundary across which two or more separate components of a computer system exchange information. For example, the data source interface 111 may include the processor 103 exchanging information with data source 113. The data source 113 may refer to a location where the data 127 originates from. The processor 103 may communicate with an input or output (I/O) interface 119 for transferring the data 127 between the processor 103 and an external peripheral device, such as sending the data 127 from the processor 103 to the peripheral device, or sending data from the peripheral device to the processor 103.

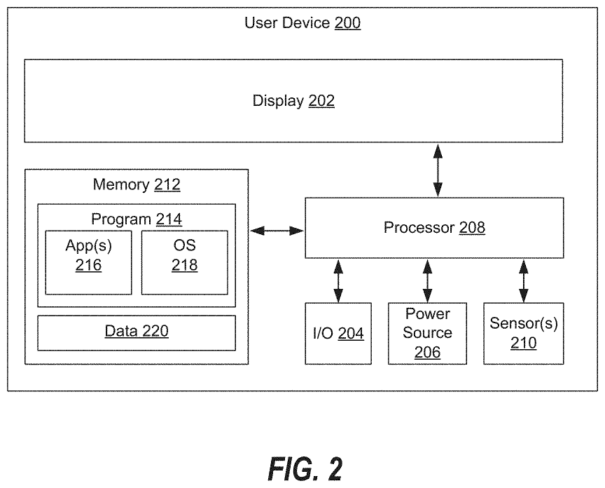

FIG. 2 illustrates a user device 200, consistent with embodiments of the present disclosure. The user device 200 shown in FIG. 2 may refer to any device, instrument, machine, equipment, or software that is capable of intercepting, transmitting, acquiring, decrypting, or receiving any sign, signal, writing, image, sound, or data in whole or in part. For example, the user device 200 may be a smartphone, a tablet, a Wi-Fi device, a network card, a modem, an infrared device, a Bluetooth device, a laptop, a cell phone, a computer, an intercom, etc. In the embodiments of FIG. 2, the user device 200 may include a display 202, an input/output unit 204, a power source 206, one or more processors 208, one or more sensors 210, and a memory 212 storing program(s) 214 (e.g., application(s) 216 and OS 218) and data 220. The components and units in the user device 200 may be coupled to each other to perform their respective functions accordingly.

As shown in FIG. 2, the display 202 may be an output surface and projecting mechanism that may show text, videos, or graphics. For example, the display 202 may include a cathode ray tube (CRT), liquid crystal display (LCD), light-emitting diode, gas plasma, or other image projection technology.

The power source 206 may refer to hardware that supplies power to the user device 200. In some embodiments, the power source 206 includes a battery. The battery may be a lithium-ion battery. Additionally, or alternatively, the power source 206 may be external to the user device 200 to supply power to the user device 200. The one or more sensors 210 may include one or more image sensors, one or more motion sensors, one or more positioning sensors, one or more temperature sensors, one or more contact sensors, one or more proximity sensors, one or more eye tracking sensors, one or more electrical impedance sensors, or any other technology capable of sensing or measuring. For example, the image sensor may capture images or videos of a user or an environment. The motion sensor may be an accelerometer, a gyroscope, and a magnetometer. The positioning sensor may be a GPS, an outdoor positioning sensor, or an indoor positioning sensor. For example, the temperature sensor may measure the temperature of at least part of the environment or user. For example, the electrical impedance sensor may measure the electrical impedance of the user. The eye-tracking sensor may include a gaze detector, optical trackers, electric potential trackers, video-based eye-trackers, infrared/near infrared sensors, passive light sensors, or other similar sensors. The program 214 stored in the memory 212 may include one or more device applications 216, which may be software installed or used on the user device 200, and an OS 218.

The server 100 shown in FIG. 1 can communicate with the user device 200 in FIG. 2 and execute corresponding computer instructions to provide a platform for an automated detection of an influencer event, perform a targeted impact determination, and generate behavioral restoration action plan accordingly. The term “influencer events” may refer to high-frequency signals (e.g., one event that may be reflected in multiple signals and/or data monitored by the system from different data sources) which are highly correlated with changes in financial outcome data. For example, some exemplary influencer events may include extreme weather conditions, such as severe wind and storms, riot situations, high spend velocity of a user, a holiday, etc. In some embodiments, the spend velocity may be determined based on an amount of money spent by a user during a predetermined time period. In addition, the spend velocity may include one or more velocity types, and each velocity type may be determined based on an amount of money of a specific type (e.g., real currency, virtual or digital currency, travel and credit card points associated with the user, etc.) spent by a user during a predetermined time period.

In various embodiments, signals indicating the influencer events may come from different types of data sources. For example, the data may be continuous (e.g., weather information of a specific location), or discrete/discontinuous (e.g., crime or emergency alerts notifying the user or residents of significant crimes or emergency incidents at or near an area). The data may also be in the form of unstructured free text, such as tweets or other social media posts or contents on various platforms.

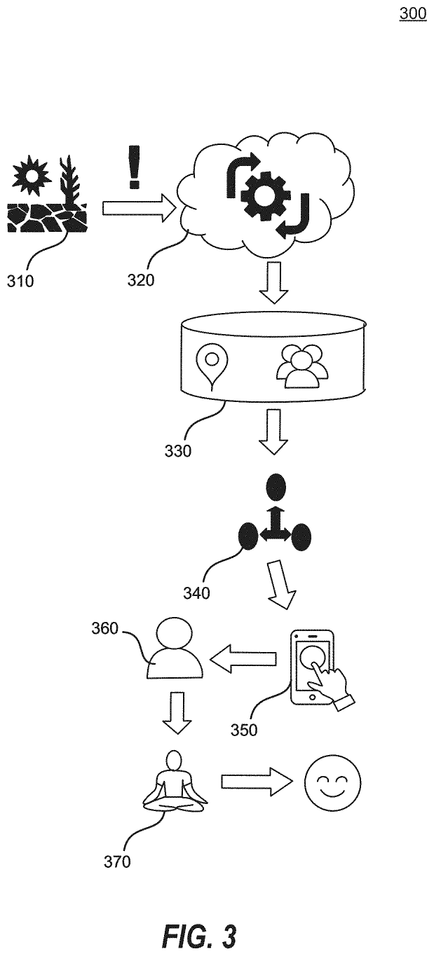

FIG. 3 shows an exemplary workflow in a first exemplary scenario 300 where the platform performs operations to detect an extreme weather event and trigger corresponding actions, consistent with some embodiments of the present disclosure. As shown in the first exemplary scenario 300, an extreme weather event 310 occurs, and, in an operation 320, the platform detects the extreme weather event 310 (through, e.g., feeds from one or more weather reporting agencies). Then, in response the detection of the extreme weather event 310, in an operation 330, the platform determines people or users who are likely affected by this event. For example, the platform may identify the target users based on location information and behavioral profiles of the users. After identifying the users who are likely affected by the event, in an operation 340, the platform may notify a corresponding system or application (e.g., a third-party service provider), or the users who will likely be affected by the event. For example, the platform may notify a self-care or mediation application installed on the user's smartphone. Accordingly, the self-care or mediation application installed on the smartphone may perform an operation 350, to notify affected user(s) 360 with recommended course of actions. In operation 370, the user may follow instructions from the application to perform the recommended activity, such as a meditation program, in order to prevent potential ill effects on the user's mental well-being due to the detected influencer event (e.g., the extreme weather).

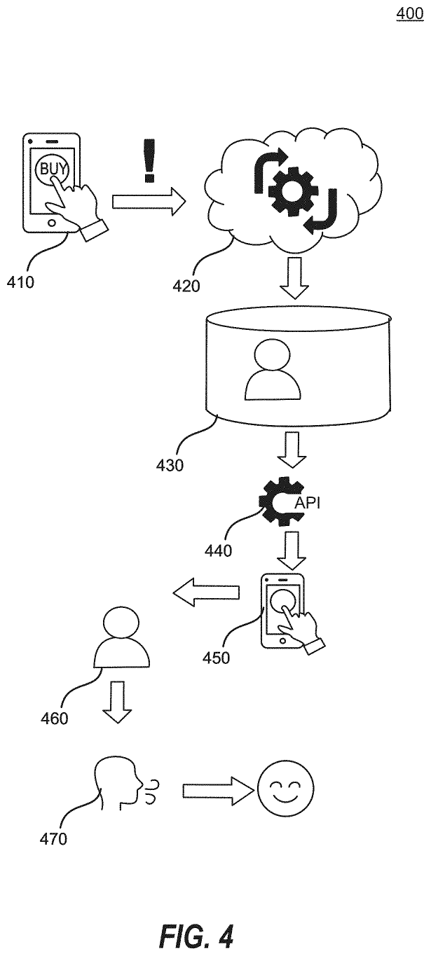

FIG. 4 shows an exemplary workflow in a second exemplary scenario 400 where the platform performs operations to detect spending anomalies and trigger corresponding actions, consistent with some embodiments of the present disclosure.

As shown in the second exemplary scenario 400, the platform may detect and monitor a user's spending activity 410 via the user device. In an operation 420, the platform detects usual spending patterns from the user in transactional financial data. In some embodiments, the detection may be performed via a third-party network implementation or offline batch analysis, but the present disclosure is not limited thereto. In response to a detection of an anomalous spending activity, in an operation 430, the platform may look up the user profile in the database and determine a corresponding action plan. Accordingly, in an operation 440 following the operation 430, the platform may push or transmit the determined action plan to the mobile Application Programming Interface (API) installed on the user device.

Accordingly, the self-care or mediation application installed on the user device may perform an operation 450, to notify affected user(s) 460 with recommended course of actions. In operation 470, the user may follow instructions from the application to perform the recommended activity, such as a breathing exercise, in order to stop the spending spree.

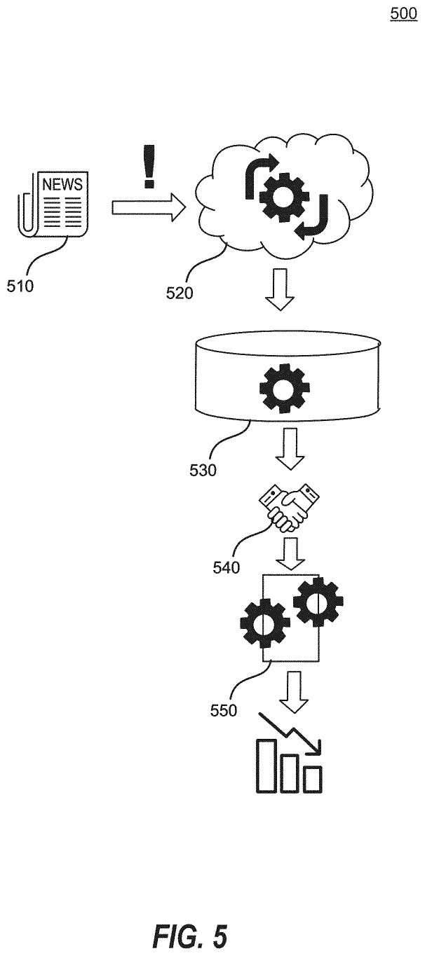

FIG. 5 shows an exemplary workflow in a third exemplary scenario 500 where the platform performs operations to detect news events and trigger corresponding actions, consistent with some embodiments of the present disclosure.

As shown in the third exemplary scenario 500, the platform may detect and monitor news events 510 to proactively react to potential fraud events. In an operation 520, the platform may process the data associated with the news events 510 using news sentiment analysis, social media monitoring, or other appropriate methods. In an operation 530, the platform generates temporary risk rules for participating users' rule engines. For example, the platform may lower the risk score threshold by 10 points or block specific IP address ranges for the participating users. Then, in an operation 540, the platform pushes new temporary rules to remote rule engines. In some embodiments, the remote rule engines may be third-party or integrated solutions.

Accordingly, the new and temporary rules 550 may enable better fraud prevention by incorporating data from the influencer event and adjusting threshold values.

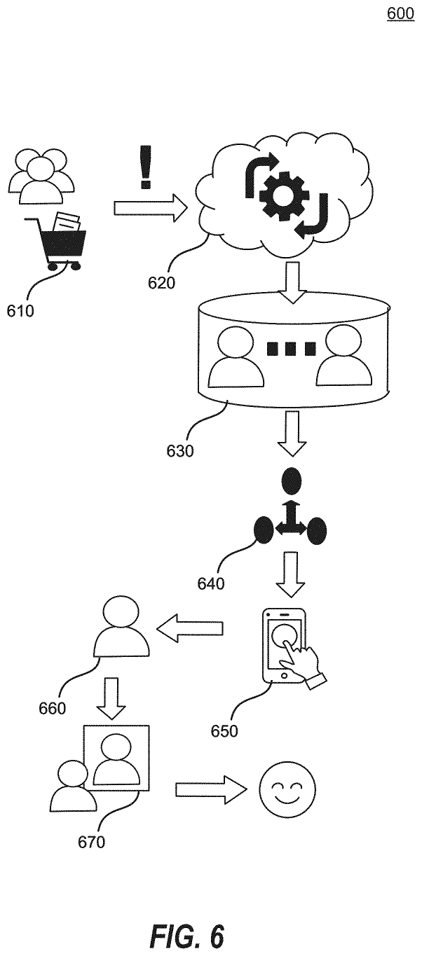

FIG. 6 shows an exemplary workflow in a fourth exemplary scenario 600 where the platform performs operations to detect network behavior anomalies and trigger corresponding actions, consistent with some embodiments of the present disclosure.

As shown in the fourth exemplary scenario 600, the platform may detect a user's spending patterns 610 via network data. In particular, in an operation 620, the platform detects usual spending patterns across a plurality of users via network data. In an operation 630, the platform queries a subset of users with spending patterns similar to those of anomalous users. In an operation 640, the platform determines an action plan for the subset of users and notifies corresponding third-party service providers with the action plan.

Accordingly, the application installed on the user device may perform an operation 650, to notify target user(s) 660 with recommended course of actions. In operation 670, the user may follow instructions from the application to perform the recommended activity, such as a reflection exercise, which in turn may lead to a more rational spending behavior.

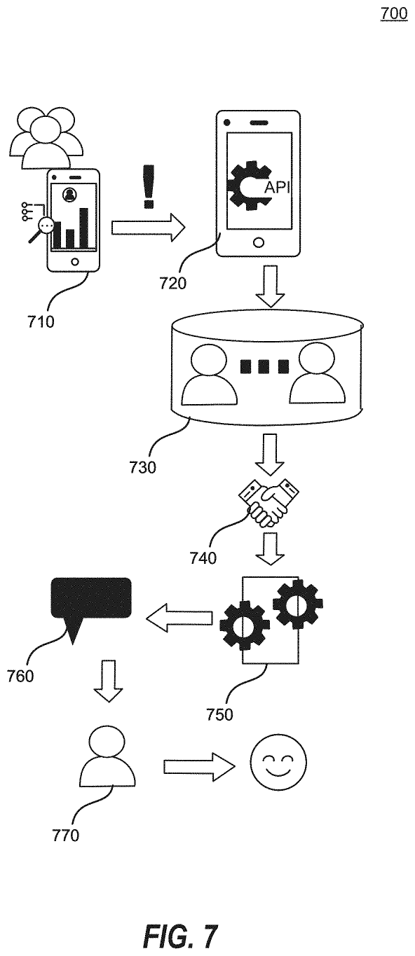

FIG. 7 shows an exemplary workflow in a fifth exemplary scenario 700 where the platform performs operations to detect anomalous device data and trigger appropriate actions, consistent with some embodiments of the present disclosure.

As shown in the fifth exemplary scenario 700, the platform may detect anomalous device data 710 on the user device. In particular, in an operation 720, the platform detects, via the mobile API, unusual behavior profile across the user device, such as erratic connectivity leading to outages. In response to the detected anomalous device data 710, in an operation 730, the platform determines an appropriate action plan base on the user profile and the anomaly class of the device data 710. Then, in an operation 740, the platform notifies downstream partners or systems of the anomalous behavior with the recommended action plan.

Accordingly, in an operation 750, the downstream partners or systems may implement the action plan accordingly. For example, a text message 760 may be sent to affected users 770 to prevent potential ill effects due to a detected influencer event and improve the user experience accordingly.

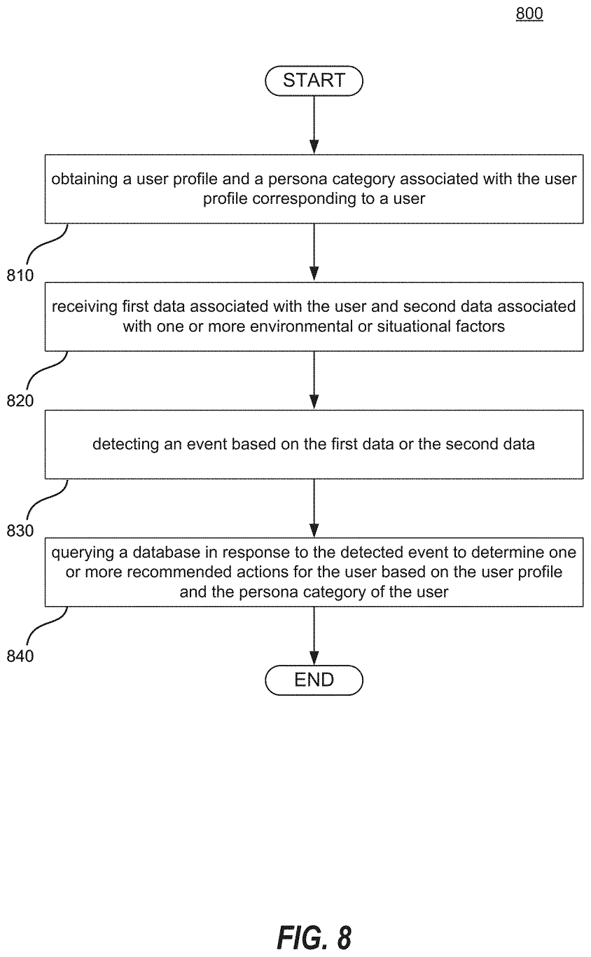

FIG. 8 is a flowchart diagram of an exemplary computer-implemented method 800 for event detection, consistent with some embodiments of the present disclosure. For example, the method 800 can be performed or implemented by software stored in a machine learning device or a computer system, such as the server 100 in FIG. 1 and/or the user device 200 in FIG. 2. For example, the memory 105 in the server 100 may be configured to store instructions, and the one or more processors 103 in the server 100 may be configured to execute the instructions to cause the server 100 to perform the method 800.

As shown in FIG. 8, in some embodiments, method 800 includes steps 810-840, which will be discussed in the following paragraphs.

At step 810, the server 100 may obtain a user profile and a persona category associated with the user profile corresponding to a user. For example, in some embodiments, the persona category is obtained by using prebuilt semi-supervised graph-based AI/ML technology during the onboarding process when the user signs up on the platform. In some embodiments, the method 800 can be applied in various financial applications, and the system may use a series of AI/ML models to determine the user's baseline personality and assign users to different groups based on types of external signals that are likely to affect the user's financial decision-making.

For example, the user's baseline risk propensity may be determined by using analysis of purchase history, results from a questionnaire based on surveys, free text analysis, regional demographic analysis, event and situational analysis, device data and digital footprint, or any combination thereof, but the present disclosure is not limited thereto. Examples of questionnaires may include DOSPERT Scale, Eysenck's Impulsivity Scale (EIS), and Zuckerman's Sensation Seeking Scale (SSS).

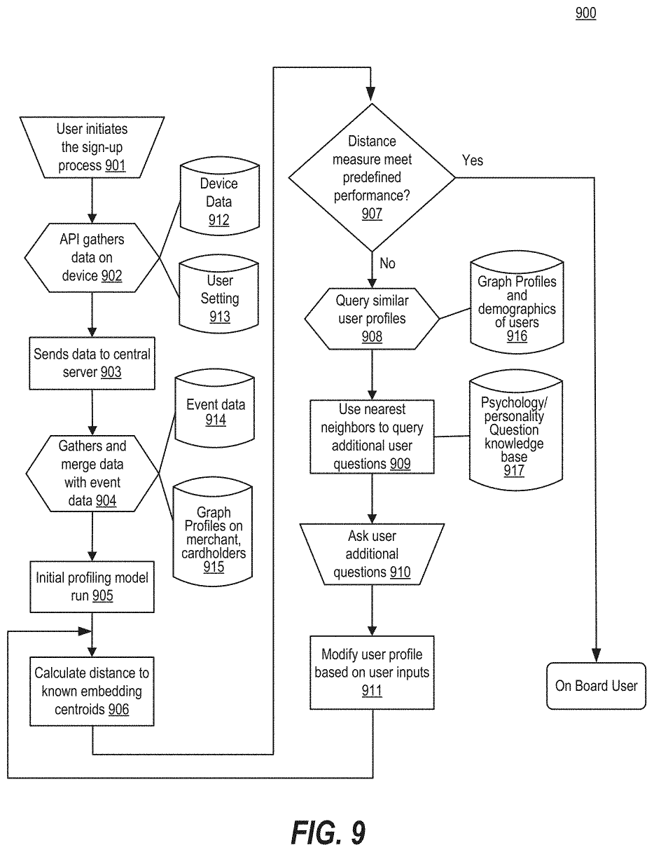

Reference is made to FIG. 9, which illustrates operations performed during the onboarding process, consistent with some embodiments of the present disclosure. In some embodiments, the operations described in the embodiments of FIG. 9 may be performed by a computer system (e.g., the server 100 of FIG. 1) for obtaining the user profile and the persona category corresponding to the user profile.

In steps 901-905, the system may generate the user profile based on data from a device of the user, and data associated with the one or more environmental or situational factors. In some embodiments, the data associated with the one or more environmental or situational factors may include location information and weather information.

For example, the user may begin at step 901, which may include a sign-up process when a customer signs up with a financial institution. At step 902, the API gathers data on a user device (e.g., the user device 200 of FIG. 2), which may include collecting the device data 912 and the user setting data 913. At step 903, the collected data is sent to a central server (e.g., the server 100 of FIG. 1). Then, at step 904, the system may gather and merge data collected from the user device with event data. For example, the data may include event data 914, which may include, for example, news and/or weather data, graph profiles on merchants and cardholders 915, user history data, etc. At step 905, the system may run an initial profiling model. For example, in some embodiments, the system may build one or more personality or emotional profile models for the persona category using a wavelet analysis model, a natural language processing (NLP) embedding model, a graph embedding model, a semi-supervised model, or any combination thereof. For example, the profiling model may also be built using a combination of other data processing or data analysis methods, such as using various semi-supervised AI and ML learners.

In some embodiments, the data sources used in the models may include psychology studies correlating financial outcome to key physiological measures, financial transactional data, NLP embeddings, user digital footprint, event data, and/or other open datasets or census data, etc. An example of the psychology studies may be the study of the influence of exploitive motifs on purchase behavior given personality traits and a modified coin toss experiment to determine truthfulness under a variety of purchase scenarios. An example of the financial transactional data may include credit card or purchase card transactions. In some embodiments, the NLP embeddings may be built from, but not limited to, tweets, financial complaints, and/or merchant's websites. The event data may include weather data, news data, sporting event data, tweets or other social media posts or contents on various platforms.

Accordingly, the system is configured to fit the prebuilt semi-supervised graph-based AI/ML model to determine a user's baseline emotional/psychological profile correcting for environmental factors (e.g., location information) and situational events (e.g., weather information).

In steps 906-908, the system may calculate one or more distance values between existing user profiles and the user profile to obtain one or more neighboring user profiles associated with the user profile. In particular, after the system estimates the user profile, at step 906, the system may perform a calculation that determines distance to known embedding centroids, and compare attributes of the user profile with the center centroids of closest profile embeddings. In some embodiments, at step 907, the system may determine whether the distance measure meets desirable characteristics or predefined performance values. In response to a determination that the measure meets the criteria (step 907—yes), the following steps may be skipped accordingly, and the system may complete the onboarding process. Otherwise (step 907—no), in step 908, the system may query similar user profiles using a database 916 storing graph profiles and demographics of existing users.

Then, in steps 909 and 910, the system may generate a customized questionnaire based on the one or more similar user profiles. In some embodiments, the similar user profiles may include neighboring user profiles determined based on the position of the user profile relative to existing user profiles. For example, at step 909, the system may use nearest neighboring user profiles to query additional user questions based on a knowledge base 917. Data from knowledge base 917 may include data associated with psychology/personality questions. Accordingly, based on the additional user questions, at step 910, the system may generate a questionnaire containing these questions in order to refine the user profile by asking the user additional questions. For example, the system may refine the measurement of the user's risk aversion and core personality traits based on those distance measures. In some embodiments, the questionnaire may include text, images, videos, or any combination thereof, and provide different types of survey questions, such as multiple-choice questions, rating scale questions, Likert scale questions, matrix questions, dropdown questions, open-ended questions, demographic questions, ranking questions, etc. Similarly, the user's response to the questionnaire can be in different forms, including text, multiple choice, multi-select text, images, or any combination thereof.

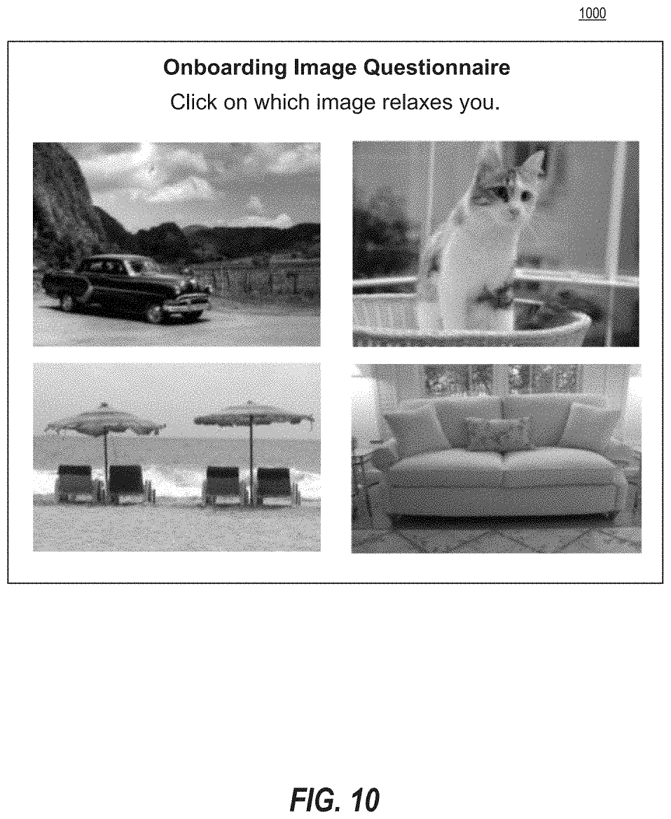

Reference is made to FIG. 10, which illustrates an exemplary questionnaire 1000 generated by the system, consistent with some embodiments of the present disclosure. As shown in FIG. 10, the questionnaire 1000 provides images of a cat, a car, a sofa, and a beach, and asks the user to select one from the four images that relaxes the user. Based on studies, this question may be used to measure personality traits and to discover how much the user's behavior varies from high to low in the five personality traits, including openness, conscientiousness, extraversion, agreeableness and neuroticism. For example, the openness may correspond to the cat image and the car image, the conscientiousness may correspond to the cat image and the sofa image, the extraversion may correspond to the car image and the beach image, the agreeableness may correspond to the cat image and the beach image, and the neuroticism may correspond to the sofa image. The images and identification of their corresponding personality trait described herein are only exemplary and not intended to be limiting. Accordingly, the system may refine the user profile using the feedback from the user, based on these modern and traditional studies in psychology.

Referring again to FIG. 9, at step 911, the system may receive user input from the user in response to the customized questionnaire and modify the user profile based on the user input to obtain a modified user profile. In some embodiments, the system may further use the data to identify, based on network data built from other users' profiles and external data, the user communities or groups to determine the persona category associated with the user profile.

As shown in FIG. 9, after the user profile is modified in the step 911, steps 906-911 may be repeated to perform iterative calculations until the user profile data is optimized. Then, the system may match the modified user profile to a corresponding persona category selected from multiple predetermined persona profiles, to obtain the corresponding persona category.

In view of the above, as shown in the embodiments of FIG. 9, at the onboarding, the system fits the prebuilt semi-supervised graph-based AI/ML model to determine a user's baseline emotional/psychological profile correcting for environmental factors (e.g., location) and situational events (e.g., weather). After a user profile is estimated, the attributes of the user profile may be compared with the center centroids of closest profile embeddings. Then, the system automatically generates a questionnaire for refining the user profile, including the measurement of the user's risk aversion and core personality traits accordingly. Thus, the user profile and the persona category associated with the user profile corresponding to the user may be obtained.

Referring again to FIG. 8, at step 820, the server 100 may receive first data associated with the user and second data associated with one or more environmental or situational factors. In some embodiments, the second data may include one or more of news sentiment information, and weather information. In some embodiments, the first data associated with the user may include financial event information. Accordingly, the system can monitor event data which may be correlated to poor financial decision-making (both at an individual level and a group level). In various embodiments, the system may offer a platform to proactively react to potential fraud events based on data such as news sentiment and weather, and to monitor the user's activities for identifying other issues, such as cognitive impairments, that may impact decision making. For example, the system may monitor the user's activities through transaction history, browsing history, emails, Wi-Fi connection properties (e.g., public, home, etc.). The system may monitor events activity from: weather data, news sentiment analysis, social media monitoring, disaster alerts, data breaches, etc.

Then, at step 830, the server 100 may detect an event based on the first data or the second data. At step 840, the server 100 may query a database in response to the detected event to determine one or more recommended actions for the user based on the user profile and the persona category of the user. Thus, when the influencer event occurs, the system may determine the best course of action, and then, if warranted, send alerts with an action plan to both internal and/or third-party applications to encourage users to engage in stress relief activity. For example, the system may integrate with third-party applications for mindfulness, stress reduction, and meditation, and/or integrate with fraud solutions to recommend new temporary rules for rule engines.

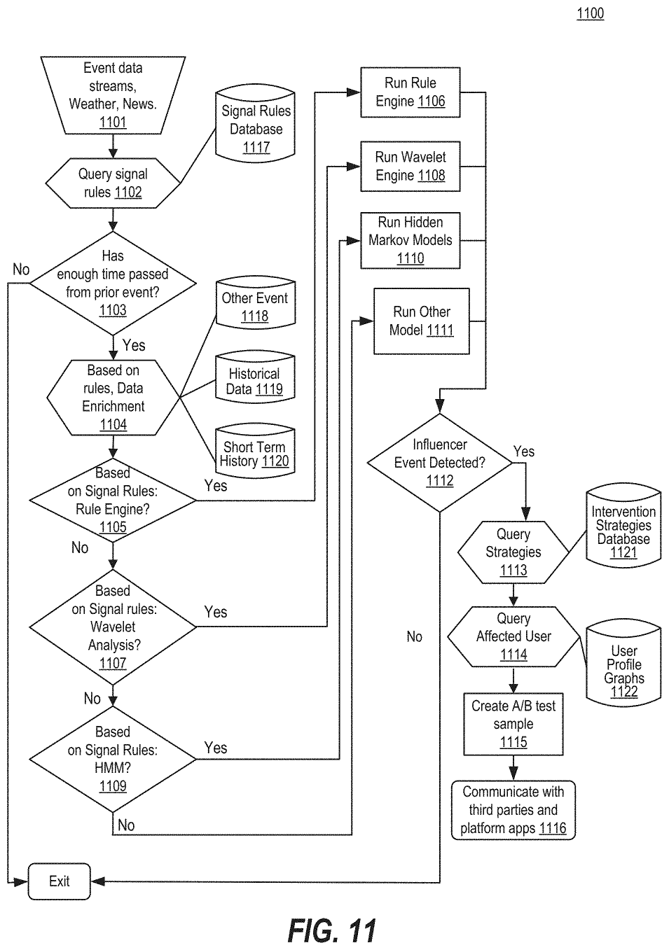

Reference is made to FIG. 11, which illustrates a flowchart 1100 of exemplary detailed operations performed for the influencer event detection in steps 820-840, consistent with some embodiments of the present disclosure. Steps 1101-1104 may correspond to step 820, in which the first data associated with the user and the second data associated with one or more environmental or situational factors are received and combined.

At step 1101, the system receives data signals from several data sources, such as event data streams, weather, news, etc. At step 1102, the system may query signal rules corresponding to the received data signals from a signal rules database 1117. In some embodiments, the signal rules may be applied to facilitate later data processing and analysis. At step 1103, the system determines whether a predetermined time period has passed from a prior event. If not (step 1103—no), the system may terminate the influencer event detection process and stop further data processing. Otherwise (step 1103—yes), the system continues the data processing and, at step 1104, perform a data enrichment process based on the applied rules. For example, during the data enrichment process, additional data, including one or more of other event data 1118, historical data 1119, and short-term history data 1120 may be combined together.

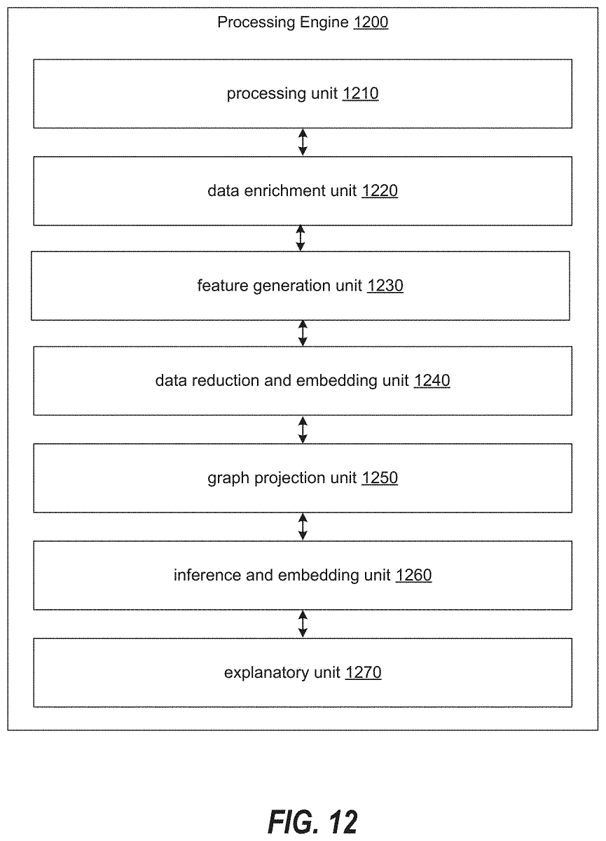

In some embodiments, the system may use different data sources to create a common topology from the disparate event data. This topology may be a graph topology stored in a graph database, and can be interrogated from different dimensions. Details of the graph topology will be further discussed in the embodiments of FIGS. 12-19. For example, the system may focus on situational and environmental factors, but the present disclosure is not limited thereto. Types of data applied in the data enrichment process may vary depending on applications or other factors. Examples of data applied in the data enrichment process may include account history, vehicle accident records, local and national holidays, merchant network, news sentiment, daily weather conditions (e.g., temperature, humidity, wind, etc.), location data (hotels, schools, churches, etc.), daily sporting events, daily national disasters, device data (e.g., exploits), breach data from the dark web, IP address network data, aggregated personality traits studies, persona library, merchant profiles and firmographics, health data (e.g., COVID-19, flu, etc.).

In some embodiments, steps 1105-1112 correspond to step 830, in which the influencer event can be detected based on the received first and second data. For example, detecting the event can be performed using one or more of models including a wavelet analysis model, a Hidden Markov model, an evolutionary learning model, a semi-supervised graph learning model, or an unsupervised graph learning model. Specifically, at step 1105, the system may determine whether to run a rule engine based on the applied rules. If so (step 1105—yes), at step 1106, the system runs the rule engine accordingly. Otherwise (step 1105—no), at step 1107, the system may determine whether to run the wavelet analysis based on the applied rules. If so (step 1107—yes), at step 1108, the system runs the wavelet analysis accordingly. Otherwise (step 1107—no), at step 1109, the system may determine whether to run the Hidden Markov models based on the applied rules. If so (step 1109—yes), at step 1110, the system runs the Hidden Markov models accordingly. Otherwise (step 1109—no), at step 1111, the system may run a default model accordingly. In other words, in steps 1105-1111, the system may select a proper method for analyzing the data and detecting whether an influencer event occurs. It is noted that the steps illustrated in FIG. 11 is merely an example and not meant to limit the present disclosure. In various embodiments, the system may adopt different methods accordingly based on actual needs. In addition to the wavelet analysis and Hidden Markov models, some other exemplary methodologies may include Modified Evolutionary learners based on an Ant Colony with agent specialization and rival hives. For example, agents can have a variety of different detection specializations (e.g., wavelets, UMAP, etc.), and the portion of specialization is driven by an adversarial hive. In some other embodiments, the system may perform anomalies detection using semi-supervised or unsupervised graph learners.

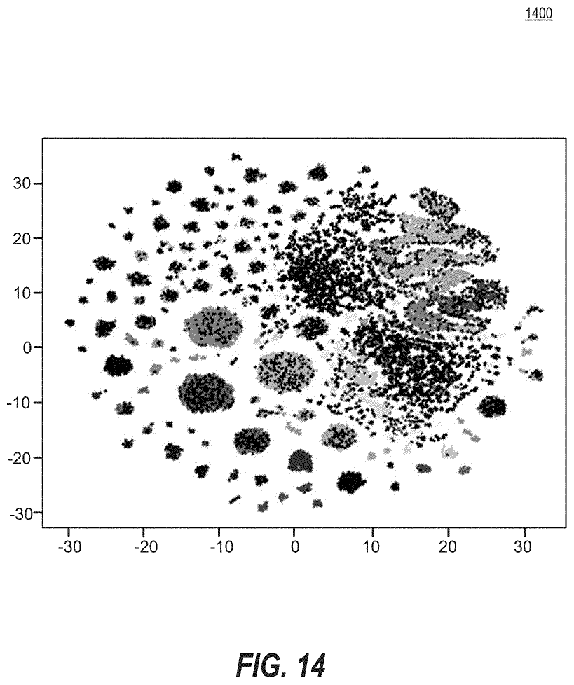

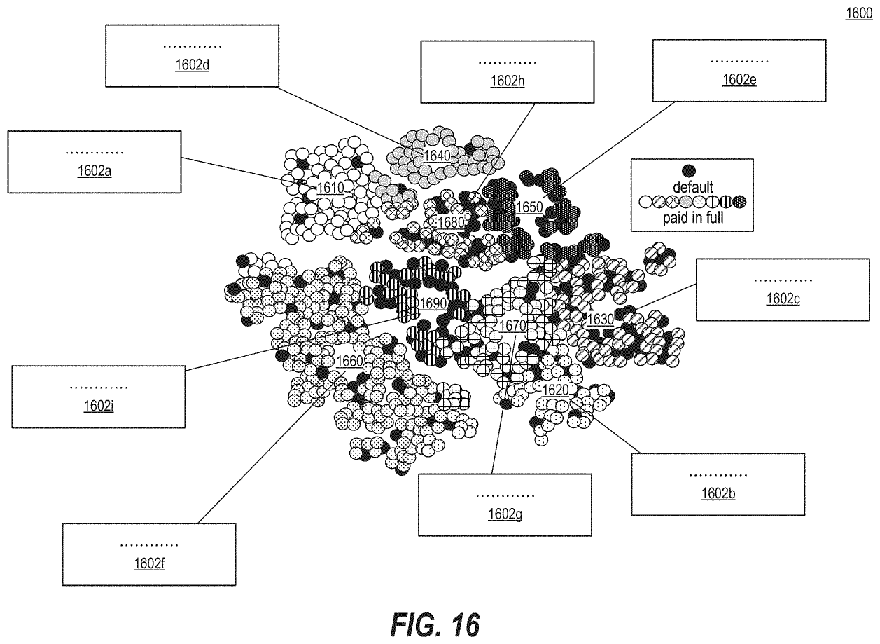

Then, at step 1112, the system may determine whether an influencer event is detected based on the analysis performed in any of steps 1106, 1108, 1110, and 1111. In response to a detection of the influencer event (step 1112—yes), the system may continue to perform steps 1113-1116. Otherwise (step 1112—no), the system may terminate the influencer event detection process. In addition, in some embodiments, once influencer events are detected, the radius value of impact can be determined to the detected event by a sensitivity analysis under different signal decay functions. This radius value may represent an impact radius on a cluster graph (e.g., in FIG. 14 or FIG. 16), and user profiles within the region of the impact radius are substantially influenced by this event. Thus, by the above operations, the system may continuously monitor users' financial events and situational data, including news sentiment information, weather information, etc., to detect whether a regime shift occurs, whether one or more critical thresholds are met, or whether anomalies in behavior patterns are identified. If any of the above conditions are met, the system may signal downstream processes that an influencer event occurs with associated users who are likely affected by the event.

It is noted that, in some embodiments, the system may collect data surrounding the influencer event (e.g., other nearby events based on temporal proximity or geolocation proximity, location demographic data, etc.) and run through a series of unsupervised and/or supervised modeling. AI/ML models may determine the likelihood or probability of whether the event will alter the users' baseline emotional state sufficiently to be detrimental to the users' decision-making process. In some embodiments, the system may also randomly target affected users to run an experiment for future analysis, if the current model(s) are unable to provide sufficient resolution.

In some embodiments, the system may build outcome models, which are supervised and/or semi-supervised models, using financial outcome data, data collected from the detected influencer event(s), and segments derived from the one or more personality or emotional profile models under the detected event. For example, the outcome models may use ensemble tree or deep learner techniques depending on the outcome data.

After the outcome models are built, the semi-supervised models may be overlaid across the embedding topology to create a multi-dimensional, queryable, information space. From the information space, each community group's behavior is correlated to influencer event category and attributes (e.g., higher or lower than the typical value) that are likely to negatively impact the community member's decision-making process.

In some embodiments, steps 1113-1116 correspond to step 840, in which one or more databases can be queried to determine the corresponding action to the user based on the user profile and the persona category, in response to the detection of the event. In particular, when the influencer event is detected, at step 1113, the system may query one or more corresponding strategies from an intervention strategies database 1121. Specifically, the system may determine one or more appropriate strategies from a bank of available intervention strategies based on the outcome analysis and phycological studies described above. These strategies are then loaded to an action plan database with fuzzy keys linking the recommendation to a class of influencer events.

At step 1114, based on the identified strategy, the system may query one or more affected users according to corresponding user profile graphs 1122. In some embodiments, in steps 1113 and 1114, the system may first query existing events and corresponding actions based on characteristics of the existing events. Then, the system selects, from the existing events, a similar event corresponding to the detected event, and determine the one or more recommended actions based on the similar event. More particularly, the system may query an action tree database using the influencer event and location as a key. If a predetermined action plan is uncovered, the system uses the predetermined rule. If no rule is found, the system may query a graph of prior events and action plans based on key attributes of the events, such as the base type (e.g., weather, conflict, etc.), time, location, scope, severity, and subtype (e.g., heat, cold, internet outage, etc.), to find the most similar event and then use the corresponding action plan as the recommended action. In one example, an action plan may be to meditate for 10 minutes. In another example, a more complex action plan may involve multiple applications or systems to reduce the score threshold for fraud models, to disconnect the user from the public Wi-Fi, and to pause to use the meditation application.

At step 1115, the system may further create A/B testing samples, where different groups of similarly affected users may be subject to different intervention strategies to assess, for example, effectiveness of the intervention strategies. Thus, after the event, the system may solicit feedback from users as well as conduct automated outcome analysis to refine the model(s) using, for example, the A/B testing.

The system can monitor key signals and, when the influencer event is detected, send automatic alerts to third-party and embedded tools. Particularly, at step 1116, the system communicates with third-party and platform applications to perform the corresponding action. In response to the determined one or more recommended actions, the system may output an alert to notify a corresponding system of the influencer event(s) and subsequent action plan(s). In some embodiments, the corresponding system may be downstream partners and systems such as the user device, other electronic devices linked with the user, or third-party and platform applications, but the present disclosure is not limited thereto. For example, the system can send an alert to third-party emotional maintenance tools, such a meditation application. In some other embodiments, the system can send an alert to integrated digital intervention tools to stem adverse behaviors, or other third-party platforms for downstream decision making.

After the influencer event, the system may also gather outcome data and may query participants about the effectiveness of the system response. For example, after the influencer event occurs, the system may randomly question users, both inside and outside of the event's impact radius, regarding the event's effect on them and whether the intervention strategy (if applicable) on them is successful. The data can then be used to refine automated strategies detection models, influencer event models, developing new action plans, refining existing action plans, and/or determining profiles.

Reference is made to FIG. 12, which is a diagram of an exemplary uniform processing engine 1200 for automated profiling, behavior change monitoring, and anomaly detection, consistent with some embodiments of the present disclosure. The processing engine 1200 includes a processing unit 1210, a data enrichment unit 1220, a feature generation unit 1230, a data reduction and embedding unit 1240, a graph projection unit 1250, an inference and embedding unit 1260, and an explanatory unit 1270. It is noted that in some embodiments, one or more of the above units 1210-1270 may be optional. In addition, the sequence of steps described below is only for illustrative purposes and not intended to be limited to any particular sequence of steps. As such, those skilled in the art can appreciate that these steps can be performed in a different order.

The processing unit 1210 is configured to process different event data streams to obtain the source data received from the data sources. In some embodiments, the engine is fully configurable using a standardized data format and model configuration recipe. For example, the fully configurable configuration file may be a JSON file, which is an open standard file format and data interchange format using human-readable text to store and transmit data objects. The model configuration recipe enables customization of the data matching and modeling process with no code change to the processing engine 1200. In some embodiments, the system may support multiple modes, including a batch build mode, a batch inference mode, and a real-time mode.

The batch build mode may provide functions including profiling, graph networks (Net of Nets), features, random forest descriptor models, etc. The batch inference mode may provide functions including profiling, profile matching, profile drift, graph embedding, etc. The real-time mode may provide functions including profiling, profile matching, graph embedding, etc.

The data enrichment unit 1220 is configured to combine source data received from different data sources. In some embodiments, a variety of different data sources may be applied to create a common topology from the disparate event data. As explained in the above embodiments, types of data applied in the data enrichment process may vary depending on applications or other factors. Examples of data applied in the data enrichment process may include account history, vehicle accident records, local and national holidays, merchant network, news sentiment, daily weather conditions (e.g., temperature, humidity, wind, etc.), location data (hotels, schools, churches, etc.), daily sporting events, daily national disasters, device data (e.g., exploits), breach data from the dark web, IP address network data, aggregated personality traits studies, persona library, merchant profiles and firmographics, health data (e.g., COVID-19, flu, etc.).

In some embodiments, the data enrichment unit 1220 may match key transaction attributes (e.g., zip code, date, time, etc.) to internal data, external data sources, and merge in the account's historical data and graph embeddings. The graph embeddings for an exemplary merchant against the account's merchant community may be defined by past transactions. In some other embodiments, the data enrichment unit 1220 may also query other internal databases.

The system may digest the raw data from different data sources into one unified structure by using various tools. For example, data can be first analyzed in a quality control tier to look for data outliers and anomalies, using standard tools such as principal component analysis, outlier detection for mixed-attribute dataset, and basic statistics to determine any irregularity. In some cases, features with significant issues can be flagged for analyst attention, and the analyst feedback for flagged features can be used if the system is not configured for full automation. On the other hand, features with significant issues may be excluded in a fully automated system.

Next, the system may correlate features with predetermined outcome features, look for linearly correlated features, and keep the ones with the highest overall predictability. For graph-based features, samples of data may be loaded into a graph. The system can exclude vertices with a low number of edges, run basic statistics such as Page Rank, and filter vertices with low graph statistics based on the graph size. In some embodiments, a large graph may need more pruning.

For surveys stored in a graph structure or similar data, if the new data source aligns with prior studies, the new data can be automatically mapped into the knowledge existing graph using subpopulation graph analysis, such as Jaccard similarity measures. Otherwise, an analysts may create a new graph to define the information space. The process mentioned above can be repeated for all predefined linkages, including zip code, shopping behaviors, mobile phone settings, etc. One example linkage is the personality traits (e.g., openness, conscientiousness, extraversion, agreeableness and neuroticism) of an individual. Then, the system may run a series of automated AI/ML supervised models to predict the survey response to mapped characteristics as defined by the previous step, and store the top preforming models.

The feature generation unit 1230 is configured to process the source data or the enriched data to obtain features for AI/ML models, by, for example, running a number of processes to transform the data to be AI/ML consumable data. The feature generation unit 1230 may include an automated time series generator configured to return features to be used in the AI/ML models.

The data reduction and embedding unit 1240 is configured to transform the source data into a uniform embedding. In some embodiments, a sequence of graph-based data reduction and unsupervised techniques may be used to generate rich metrics defining how the event relates to a general population and the event data. The data reduction and embedding unit 1240 may apply various AI/ML technologies. For example, the data reduction and embedding unit 1240 may be configured to process the source data or the enriched data by a graph embedding, a graph-based dimensionality reduction, an unsupervised cluster technique or any combination thereof. Uniform Manifold Approximation and Projection (UMAP) is one example of a machine learning technique for dimension reduction.

The graph projection unit 1250 is configured to project the uniform embedding into a uniform graph structure in a universal graph database by generating links from embedding source data using predefined metrics. In some embodiments, the graph projection unit 1250 may include a network analysis engine. In some embodiments, the uniform graph structure can be collapsed into the cluster map using different techniques based on data signals. For network features, a combination of edge filtering and community detection algorithms can be applied. For general features, such as location-based features, As discussed above, UMAP can be applied for dimension reduction.

UMAP and other AI tools may use an automated parameterization optimization process. In the parameterization optimization, the system may use prior data samples to cluster top parameter values using UMAP based on data characteristics (e.g., variability, basic statistical, min value, max value, mean value, etc.), correlation to predefined target variables (e.g., fraud), and prior performance of similar models. Then, the system may build models based on the cluster of parameters using sample data. Then, the system may calculate the best two collections of parameters and measure the model quality by looking at performances (e.g., sensitivity, specificity, etc.) of features, generated prediction target features, and cluster performance using measures such as average silhouette coefficient. Finally, the system may complete the optimization by descending from the top cluster of parameters to the next best cluster.

The inference and embedding unit 1260 is configured to embed a graph query in response to a request and to provide output data for the request by using a graph distance algorithm model. Thus, the system's output can be used by downstream supervised AI models or to enable decisions, either implemented by a rule engine or a human.

For example, a series of distance metrics may be used to define how an event in question relates to other existing events of a similar class or of different classes within the universal graph. In some embodiments, point-to-point distance metrics are calculated by taking the Euclidean distance between two observations in the compressed 2D UMAP space with the X and Y point coordinates. The distances can be normalized by adjusting for the minimum and maximum values over the entire embedded space. A series of distances may be calculated based on features which are not used to create the embedded space, such as fraud labels or any other outcomes features. For example, an average distance of a given point to the nearest 50 observations of labeled outcomes (such as fraud occurs) can be calculated.

When comparing two points in the compressed graph space, the system may calculate various features, such as the number of shared edges, the ratio of similar near observation (vertices) to a total number of nearest neighbors, percent of total weight contributed by the target observation compared to nearest neighbors, etc. In some embodiments, when comparing a target point to a subpopulation of the point, the system may use aggregated statistics from comparing each point in the subpopulation to the target point as defined above. In addition, measures such as Jaccard similarity and share of common neighbors may be used for comparing subpopulations or subgraphs.

These distance metrics provide a mapping that can be used in different manners. If the profiles are used in a downstream AI system, the cluster group may be used to segment the models and each cluster group may have a different learner. The distance metrics can then be pulled in as features as well as the UMAP features and embeddings. If the profiles are to be used directly, then rules may be set up to select the closest persona matching the current event (e.g., a bot persona). Thus, predefined action(s) (e.g., reject) can be selected and performed based on the selected persona.

The explanatory unit 1270 is configured to provide explanatory data associated with an event and a placement of the event in the uniform graph structure. In particular, when required, the system can provide human-readable explanatory values for why an event was placed where it was. In some embodiments, the system may use an adaptive supervised AI tier with feeds into any number of explanatory analysis tools. For example, the AI/ML tools applied in the explanatory unit 1270 may include graph distance algorithm, random forest algorithm, and model explainability analysis.

In some embodiments, the system may provide focused profiling of event data without any additional network overlays. For example, in some configuration, the processing engine 1200 in FIG. 12 may be configured to provide a rich analysis of an event in relationship with prior events to find anomalies, provide robust segmentation analysis, and/or provide metrics for downstream AIs and data processing.

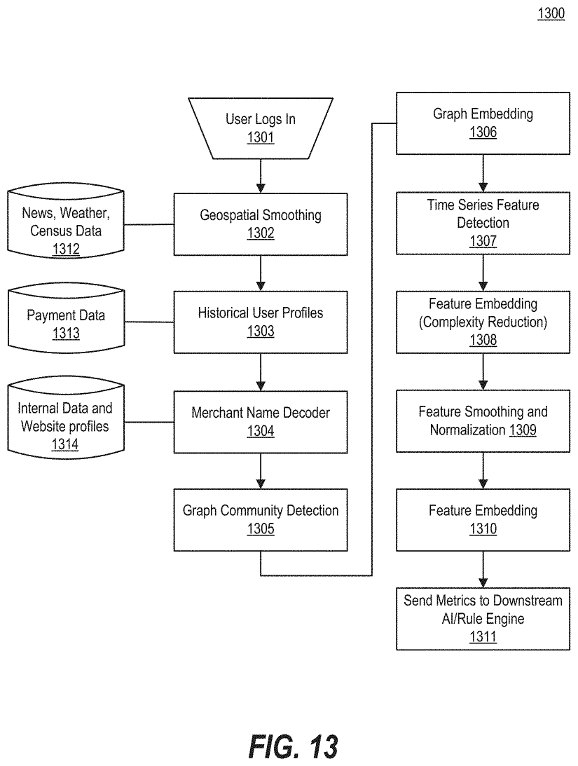

Reference is made to FIG. 13, which illustrates a flowchart 1300 of exemplary detailed operations performed by the uniform processing engine 1200 when a user logs in, consistent with some embodiments of the present disclosure.

As shown in FIG. 13, the user may begin at step 1301, logging in the system associated with the financial institution. At step 1302, the processing engine 1200 may access one or more databases to retrieve news, weather, and census data 1312 and perform geospatial smoothing operations. At step 1303, the processing engine 1200 may access one or more databases to retrieve payment data 1313 and obtain historical user profiles. At step 1304, the processing engine 1200 may further access one or more databases to retrieve other internal data and website profiles 1314, and apply a merchant name decoder to obtain information required for processing in the following steps. Then, at step 1305, the processing engine 1200 may run graph community detection process to perform the clustering.

At step 1306, the processing engine 1200 may perform graph embedding and obtain vertex distance measure from subpopulations. At step 1307, the processing engine 1200 may perform time series feature detection to obtain time series features. At step 1308, the processing engine 1200 may perform feature embedding to achieve complexity reduction. At step 1309, the processing engine 1200 may perform feature smoothing and normalization for event data, which may be updated hourly or weekly based on the data type. At step 1310, the processing engine 1200 may perform another feature embedding for multidimensional distance embedding, which may also involve historic features, profiles and/or settings. Then, at step 1311, the processing engine 1200 may send the obtained metrics to downstream AI or rule engine for further processing and/or analysis. The steps described above can be achieved by corresponding units and tiers of the processing engine 1200 as described above, and thus details are not repeated herein for the sake of brevity.

By the above operations, the system may provide an internal interface that allows execution of processes when a transaction enters the system. In particular, the transaction may go through the data enrichment phase, a feature creation phase, and a persona calculation and drift detection phase. As discussed above, during the data enrichment phase, the system matches key transaction attributes (e.g., zip code, date, time, etc.) to internal and/or external data sources, and merges in the account's historical data and graph embeddings.

In the feature generation phase, the system runs the processes to generate features for AI/ML models. It is noted that in some embodiments, not all features are used in the final model, and some features may be stored for data monitoring. The system may also provide correlation metrics using the final features for quality control purposes.

In the persona calculation and drift detection phase, the system may determine the current transaction's persona profile, create new embeddings with the new data, and calculate distance metrics to feed into the platform dashboard. In some embodiments, the system calculates new embeddings using more recent data, and determine various distance calculations, such as a distance from the last transaction and a distance from fraud personas.

Reference is made to FIG. 14. FIG. 14 is a cluster map 1400 showing exemplary clusters of identity data within the system's graph database with cluster groups and dots representing high-risk individuals, consistent with some embodiments of the present disclosure. For example, high-risk individuals may be criminals or bots.

As shown in the embodiments of FIG. 14, the system can be used to profile onboarding requests to aid in rejecting/approving the application and to enrich downstream event processing. In some embodiments, the system may only use name, age, and location for matching. Then, the system may query additional data linked to an incoming request based on education, employment history, location history, and digital footprint to an extensive historical profile library (e.g., a persona library). If the user's profile matches an existing persona from the persona library, the system can perform corresponding action, such as identifying the actor's type (e.g., bot, agent, criminal, professional, etc.), providing their relative risk ratio (e.g., 9 times out of 10 negative outcomes), and/or crafting a prescription based on the context (e.g., renewing, onboarding, change of terms, etc.).

In some embodiments, the profiles are predictive even without a supervised model. From those cluster groups shown in FIG. 14, the group with minimal intra-group variation may be chosen to create the persona library. Table 1 below is a sample of the top 5 exemplary personas and bottom 5 exemplary personas, consistent with some embodiments.

TABLE 1

| | Social | | Social | | | |
|---|---|---|---|---|---|---|
| Per- | Impor- | Educa- | Foot- | Employ- | Loca- | % Neg |
| sona | tance | tion | print | ment | tion | Outcome |
| 26 | −34.65 | −0.02 | 1.41 | −25.97 | 1.71 | 1.0 |
| 116 | 15.97 | 2.76 | 0.76 | −21.47 | −4.29 | 1.0 |
| 201 | −2.86 | 0.98 | −5.30 | 47.93 | 13.69 | 1.0 |
| 206 | −3.02 | 1.51 | −6.01 | 51.77 | 4.81 | 1.0 |
| 237 | 7.18 | 1.26 | −6.22 | 58.12 | 1.10 | 1.0 |
| 233 | 17.45 | 1.56 | 20.18 | 2.35 | 12.91 | 0.0 |
| 250 | −30.49 | 3.65 | 21.94 | 53.51 | 2.26 | 0.0 |
| 253 | 14.54 | 8.57 | −1.22 | 55.99 | −15.23 | 0.0 |
| 275 | 24.38 | 3.63 | 5.44 | 57.34 | 12.92 | 0.0 |
| 277 | 20.15 | 3.24 | 7.94 | 52.38 | 4.33 | 0.0 |

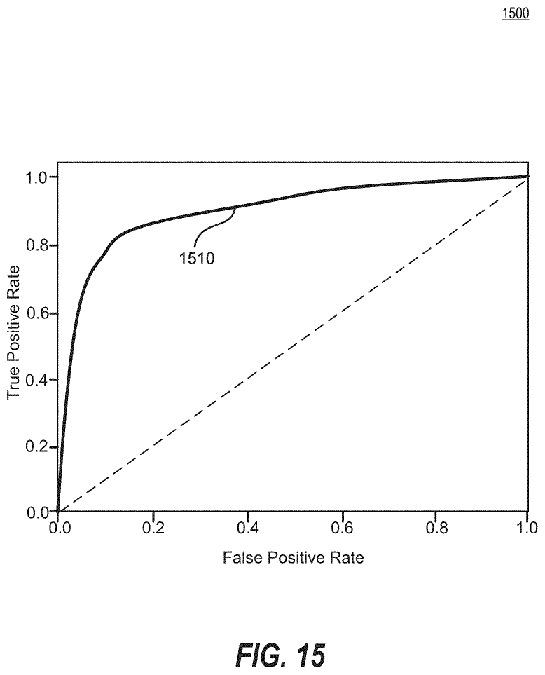

FIG. 15 illustrates a diagram 1500 showing a representative receiver operating characteristic (ROC) curve 1410 from a supervised model, consistent with some embodiments of the present disclosure. The ROC curve 1410, created by plotting the true positive rate against the false positive rate, can be used to predict if a profile was arrested using only features from the system. The true-positive rate is also known as sensitivity, recall or probability of detection. The false-positive rate is also known as probability of false alarm and can be calculated as (1—specificity).

Reference is made to FIG. 16. FIG. 16 is another cluster map 1600 showing clusters of exemplary financial data, consistent with some embodiments of the present disclosure. In the embodiments of FIG. 16, the system can blend events, such as loan applications and news sentiment, to enable an understanding of how external factors influence consumer's behavior. By detailed analysis using news and loan application network data obtained from news sentiment network(s) and the public dataset of loan requests, the system may process the merged data as a financial event and generate the resulting cluster map 1600, with the categorization of each cluster group showing in corresponding comment regions 1602a-1602i (e.g., text bubbles) in the cluster map 1600.

For example, the cluster map 1600 includes cluster groups A-I 1610-1690. The cluster group A 1610 may represent lower amount short-term loans with low interest rates for higher income individuals whose income has not been verified. Borrowers in the cluster group A 1610 have low depth-to-income ratios, high FICO scores, have made fewer credit inquiries, and have an extensive credit history. A typical borrower in the cluster group A 1610 may, for example, have borrowed the money for home improvement (as opposed to, e.g., medical purposes) and live in California or Massachusetts.

The cluster group B 1620 may represent mid-sized loans for middle-income individuals with lower FICO scores and recent delinquencies. A typical borrower in cluster group B 1620 may have few credit lines, be most likely located in California (and less likely to be located in, e.g., Kentucky) while having a high number of derogatory public records. The loan is unlikely to be joint, but when it is, the second applicant may have a low income. The loan may be for a small business.

The cluster group C 1630 may represent mid-sized loans for individuals with a higher number of tax liens, low available funds, shorter employment, and a high number of bank cards at over 75% of limit. A typical borrower in cluster group C 1630 is unlikely to have a mortgage, and may borrow for moving or a vacation.

The cluster group D 1640 may represent higher amount loans associated with financially active individuals with higher, verified, incomes. A typical borrower in cluster group D 1640 may be likely reside in California, and less likely to be located in, e.g., Ohio, Kentucky, Alabama, or Pennsylvania, and may typically rent and borrow for credit card or car purchase.

The cluster group E 1650 may represent longer-term loans with higher interest rates for individuals with low available funds, short credit histories, and higher number of recorded bankruptcies. A typical borrower in cluster group E 1650 may have shorter employment and may borrow for debt consolidation.

The cluster group F 1660 may represent low amount short-term loans with higher interest rates for middle-income individuals with a low credit balance and low credit limit. A typical borrower in cluster group F 1660 may be overrepresented in Ohio and Wisconsin and may borrow for a credit card, debt consolidation, or medical purposes.

The cluster group G 1670 may represent higher amount loans with low interest rates for individuals with high FICO scores and verified available funds but documented delinquencies and high debt-to-income ratios. A typical borrower in cluster group G 1670 may be overrepresented in Alabama and Pennsylvania and may borrow for moving or medical purposes.

The cluster group H 1680 may represent loans by individuals with previously repaid loans that typically rent. A typical borrower in cluster group H 1680 may have recent bankcard deficiencies and charge-offs. A typical borrower in cluster group H 1680 may likely be a homeowner without a mortgage. The loan may be joint for home improvement.

The cluster group I 1690 may represent higher amount, short-term loans with high interest by individuals with low FICO scores, high debt-to-income ratios, shorter credit histories, and many credit inquiries. A typical borrower in cluster group I 1690 may rent and borrow for debt consolidation.

The typical profiles of borrowers in cluster groups A-I 1610-1690 described above are only exemplary and not intended to reflect any trend in actual data or analyses.

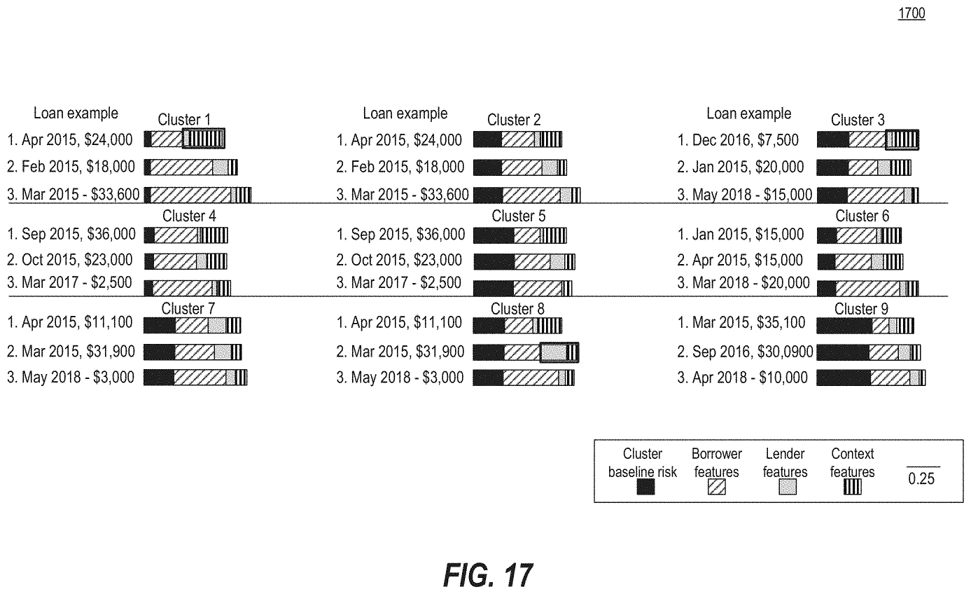

The system may use graph embedding, distance, and situation data, to run a series of models to order requests by risk. Then, by querying the cluster map 1600 and running explanatory analysis, the system may break down why each loan was considered high risk and which influenceable factors drive the results, as shown in FIG. 17. FIG. 17 illustrates a chart 1700 showing the exemplary financial data after one or more analyses, consistent with some embodiments of the present disclosure. As shown in the chart 1700, the loan examples in the same cluster group may have the same cluster baseline risk, but with different total risk values due to different borrower features, lender features, context features, etc.

Accordingly, the results obtained by the system may enable more complex decisions beyond simple decline or approve. For example, using the distance metrics, a decision-maker can determine if any factors within their controls (e.g., interest rates) can be changed to impact or adjust the outcome, understand if only situation factors (e.g., an economic downturn) is affecting the risk level of the loan, and/or see if any factors (e.g., employment history) will likely change over time indicating the applicant may be recategorized to a higher or lower risk level.

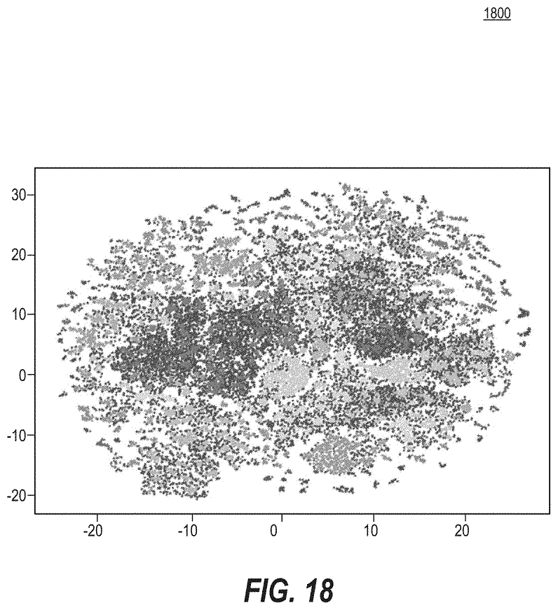

Reference is made to FIG. 18. FIG. 18 is a graph 1800 showing exemplary clusters of events and user profiles, consistent with some embodiments of the present disclosure. In the embodiments of FIG. 18, the system can blend intra network events, such as onboarding to a payment network and a payment transaction. In the example shown in the graph 1800, the purchase data and cardholder profiles are blended. Based on the graph 1800, the model may be applied to handle various questions. For example, the model may determine the most similar expected purchases pattern for an onboarding customer, whether events (such as extreme weather) influence who onboards and how they behave after onboarding, whether the current transaction indicates a shift in the customer's profile, or the type of people shopping at a particular merchant. Similar to the above embodiments, these embeddings can be used to enhance downstream models.

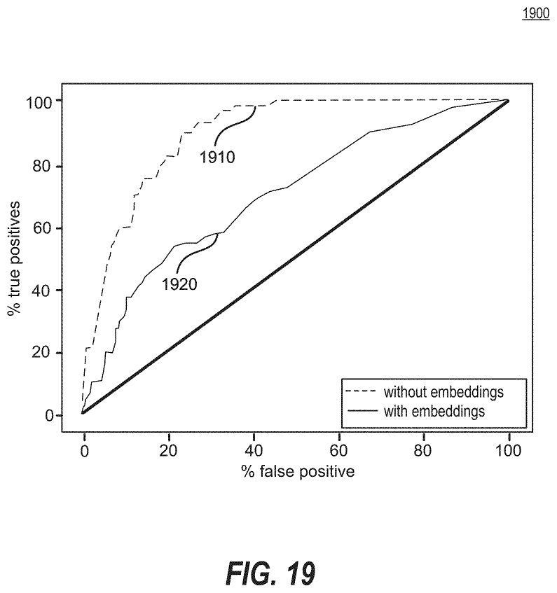

FIG. 19 illustrates a diagram 1900 showing exemplary ROC curves 1910 and 1920 for models predicting a fraudulent transaction, consistent with some embodiments of the present disclosure. The ROC curve 1910 indicates the result using the embeddings provided by the system, while the ROC curve 1920 indicates the result using a standard fraud model, thus without using the embeddings.

As shown in various examples of FIGS. 14-19, the system may enable a holistic analysis of financial event data across customer and event types, by providing a common data topology stored in the graph database coupled with an adaptive graph embedding engine (e.g., the processing engine 1200 in FIG. 12) in the computer system. The engine generates standardized and normalized features across all query dimensions. Accordingly, the system may perform a deep examination of how things, including situational factors (e.g., riots, floods, etc.) and environmental factors (e.g., number of schools, etc.), influence customer behavior through a broad range of events.

By the various embodiments of the present disclosure, the system may achieve various improvements. In particular, the system may allow for universal event monitoring through all available data channels, provide rapid anomaly detection capabilities and powerful data to power downstream AIs, enable complex decision-making by allowing users or systems to interrogate the graph from multiple dimensions, and allow additional data and/or models to be overlayed across the graph topology to enrich the knowledge space. Thus, the system may offer a proper understanding of the customer's needs and situational factors by analyzing the data and events holistically and enable intelligent decision-making.

In some embodiments, a non-transitory computer-readable storage medium including instructions is also provided, and the instructions may be executed by one or more processors of a device, to cause the device to perform the above-described methods for event detection. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that includes one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein.

The embodiments may further be described using the following clauses:

1. A method for event detection, comprising:

obtaining a user profile and a persona category associated with the user profile corresponding to a user;

receiving first data associated with the user and second data associated with one or more environmental or situational factors;

detecting an event based on the first data or the second data; and querying a database in response to the detected event to determine one or more recommended actions for the user based on the user profile and the persona category of the user.

2. The method of clause 1, wherein querying the database comprises:

querying existing events and corresponding actions based on characteristics of the existing events;

selecting, from the existing events, a similar event corresponding to the detected event; and determining the one or more recommended actions based on the similar event.

3. The method of clause 2, further comprising:

outputting an alert to a corresponding external system in response to the determined one or more recommended actions.

4. The method of any of clauses 1-3, wherein the second data associated with the one or more environmental or situational factors comprises one or more of news sentiment information, and weather information.
5. The method of any of clauses 1-4, wherein the first data associated with the user comprises financial event information.
6. The method of any of clauses 1-5, wherein detecting the event is performed using one or more of a plurality of models including a wavelet analysis model, a Hidden Markov model, an evolutionary learning model, a semi-supervised graph learning model, or an unsupervised graph learning model.
7. The method of any of clauses 1-6, further comprising:

determining a radius value of impact corresponding to the detected event by a sensitivity analysis.

8. The method of any of clauses 1-7, further comprising:

building one or more personality or emotional profile models for the persona category using a wavelet analysis model, a natural language processing (NLP) embedding model, a graph embedding model, a semi-supervised model, or any combination thereof.

9. The method of clause 8, further comprising:

building one or more outcome models using financial outcome data, third data collected from the detected event, and segments derived from the one or more personality or emotional profile models under the detected event, the one or more outcome models being supervised or semi-supervised models.

10. The method of any of clauses 1-9, wherein the persona category is obtained by:

generating the user profile based on third data from a device of the user, and fourth data associated with the one or more environmental or situational factors;

calculating one or more distance values between existing user profiles and the user profile to obtain one or more neighboring user profiles associated with the user profile;

generating a customized questionnaire based on the one or more neighboring user profiles;

receiving user input from the user in response to the customized questionnaire;

modifying the user profile based on the user input to obtain a modified user profile; and

matching the modified user profile to a corresponding persona category selected from a plurality of predetermined persona profiles.

11. The method of clause 10, wherein the one or more environmental or situational factors comprise location information and weather information.
12. A computer system, comprising:

a memory configured to store instructions; and

one or more processors configured to execute the instructions to cause the computer system to:
obtain a user profile and a persona category associated with the user profile corresponding to a user;
receive first data associated with the user and second data associated with one or more environmental or situational factors;
detect an event based on the first data or the second data; and
query a database in response to the detected event to determine one or more recommended actions for the user based on the user profile and the persona category of the user.
   13. The computer system of clause 12, wherein the one or more processors is configured to execute the instructions to cause the computer system to query the database by:

querying existing events and corresponding actions based on characteristics of the existing events;

selecting, from the existing events, a similar event corresponding to the detected event; and

determining the one or more recommended actions based on the similar event.

14. The computer system of clause 13, wherein the one or more processors is configured to execute the instructions to cause the computer system to:

output an alert to a corresponding external system in response to the determined one or more recommended actions.

15. The computer system of any of clauses 12-14, wherein the second data associated with the one or more environmental or situational factors comprises one or more of news sentiment information, and weather information.
16. The computer system of any of clauses 12-15, wherein the first data associated with the user comprises financial event information.
17. The computer system of any of clauses 12-16, wherein detecting the event is performed using one or more of a plurality of models including a wavelet analysis model, a Hidden Markov model, an evolutionary learning model, a semi-supervised graph learning model, or an unsupervised graph learning model.
18. The computer system of any of clauses 12-17, wherein the one or more processors is configured to execute the instructions to cause the computer system to:

determine a radius value of impact corresponding to the detected event by a sensitivity analysis.

19. The computer system of any of clauses 12-18, wherein the one or more processors is configured to execute the instructions to cause the computer system to:

build one or more personality or emotional profile models for the persona category using a wavelet analysis model, a natural language processing (NLP) embedding model, a graph embedding model, a semi-supervised model, or any combination thereof; and

build one or more outcome models using financial outcome data, third data collected from the detected event, and segments derived from the one or more personality or emotional profile models under the detected event, the one or more outcome models being supervised or semi-supervised models.

20. A computer system, comprising:

a data enrichment unit configured to combine source data received from a plurality of data sources;

a data reduction and embedding unit configured to transform the source data into a uniform embedding; and

a graph projection unit configured to project the uniform embedding into a uniform graph structure by generating links from embedding source data using predefined metrics.

What is claimed is:

1. A method for event detection, comprising:
obtaining a user profile and a persona category associated with the user profile corresponding to a user;
receiving first data associated with the user and second data associated with one or more environmental or situational factors;
detecting an event based on the first data or the second data; and
querying a database in response to the detected event to determine one or more recommended actions for the user based on the user profile and the persona category of the user.

2. The method of claim 1, wherein querying the database comprises:
querying existing events and corresponding actions based on characteristics of the existing events;
selecting, from the existing events, a similar event corresponding to the detected event; and
determining the one or more recommended actions based on the similar event.

3. The method of claim 2, further comprising:
outputting an alert to a corresponding external system in response to the determined one or more recommended actions.

4. The method of claim 1, wherein the second data associated with the one or more environmental or situational factors comprises one or more of news sentiment information, and weather information.

5. The method of claim 1, wherein the first data associated with the user comprises financial event information.

6. The method of claim 1, wherein detecting the event is performed using one or more of a plurality of models including a wavelet analysis model, a Hidden Markov model, an evolutionary learning model, a semi-supervised graph learning model, or an unsupervised graph learning model.

7. The method of claim 1, further comprising:
determining a radius value of impact corresponding to the detected event by a sensitivity analysis.

8. The method of claim 1, further comprising:
building one or more personality or emotional profile models for the persona category using a wavelet analysis model, a natural language processing (NLP) embedding model, a graph embedding model, a semi-supervised model, or any combination thereof.

9. The method of claim 8, further comprising:
building one or more outcome models using financial outcome data, third data collected from the detected event, and segments derived from the one or more personality or emotional profile models under the detected event, the one or more outcome models being supervised or semi-supervised models.

10. The method of claim 1, wherein the persona category is obtained by:
generating the user profile based on third data from a device of the user, and fourth data associated with the one or more environmental or situational factors;
calculating one or more distance values between existing user profiles and the user profile to obtain one or more neighboring user profiles associated with the user profile;
generating a customized questionnaire based on the one or more neighboring user profiles;
receiving user input from the user in response to the customized questionnaire;
modifying the user profile based on the user input to obtain a modified user profile; and
matching the modified user profile to a corresponding persona category selected from a plurality of predetermined persona profiles.

11. The method of claim 10, wherein the one or more environmental or situational factors comprise location information and weather information.

12. A computer system, comprising:
a memory configured to store instructions; and
one or more processors configured to execute the instructions to cause the computer system to:
obtain a user profile and a persona category associated with the user profile corresponding to a user;
receive first data associated with the user and second data associated with one or more environmental or situational factors;
detect an event based on the first data or the second data; and
query a database in response to the detected event to determine one or more recommended actions for the user based on the user profile and the persona category of the user.

13. The computer system of claim 12, wherein the one or more processors is configured to execute the instructions to cause the computer system to query the database by:
querying existing events and corresponding actions based on characteristics of the existing events;
selecting, from the existing events, a similar event corresponding to the detected event; and
determining the one or more recommended actions based on the similar event.

14. The computer system of claim 13, wherein the one or more processors is configured to execute the instructions to cause the computer system to:
output an alert to a corresponding external system in response to the determined one or more recommended actions.

15. The computer system of claim 12, wherein the second data associated with the one or more environmental or situational factors comprises one or more of news sentiment information, and weather information.

16. The computer system of claim 12, wherein the first data associated with the user comprises financial event information.

17. The computer system of claim 12, wherein detecting the event is performed using one or more of a plurality of models including a wavelet analysis model, a Hidden Markov model, an evolutionary learning model, a semi-supervised graph learning model, or an unsupervised graph learning model.

18. The computer system of claim 12, wherein the one or more processors is configured to execute the instructions to cause the computer system to:
determine a radius value of impact corresponding to the detected event by a sensitivity analysis.

19. The computer system of claim 12, wherein the one or more processors is configured to execute the instructions to cause the computer system to:
build one or more personality or emotional profile models for the persona category using a wavelet analysis model, a natural language processing (NLP) embedding model, a graph embedding model, a semi-supervised model, or any combination thereof; and
build one or more outcome models using financial outcome data, third data collected from the detected event, and segments derived from the one or more personality or emotional profile models under the detected event, the one or more outcome models being supervised or semi-supervised models.

20. A computer system, comprising:
a data enrichment unit configured to combine source data received from a plurality of data sources;
a data reduction and embedding unit configured to transform the source data into a uniform embedding; and
a graph projection unit configured to project the uniform embedding into a uniform graph structure by generating links from embedding source data using predefined metrics.
